(19) United States
(12) Patent Application Publication
(10) Pub. No.: US 2008/0147885 A1
(43) Pub. Date: Jun. 19, 2008

(54) SYSTEMS AND METHODS FOR RESOLVING RESOURCE NAMES TO IP ADDRESSES WITH LOAD DISTRIBUTION AND ADMISSION CONTROL

(75) Inventor: Thierry Bessis, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc., Murray Hill, NJ (US)

(21) Appl. No.: 11/611,854

(22) Filed: Dec. 16, 2006

(51) Int. Cl. G06F 15/16

(52) U.S. Cl. 709/250

(57) ABSTRACT

Systems and methods are disclosed for resolving URIs to IP addresses and port numbers in an intranet, in which the host processors of the intranet individually maintain a data store with entries indicating the status of service application ports provided by the other hosts of the intranet, and URIs within the intranet are resolved at the host processing nodes without DNS server consultation by local address resolution components that provide load shedding and load balancing according to the data store entries.

### BACKGROUND OF THE INVENTION

The present invention relates generally to IP address resolution and finds particular utility in resolving universal resource identifiers (URIs) to IP addresses and port numbers for host processing nodes constituting a local intranet. In the distributed processing to implement various services and protocols in packet switched processing systems and networks, many protocols run over the Internet Protocol (IP). Examples include session initiation protocol (SIP) used in providing IP multimedia subsystem (IMS) services, in which individual call instances require interoperation of many SIP components to provide the desired multimedia services. In a typical scenario, many of the SIP components are members of a local data center or intranet sharing a common domain, for example, within a single office complex or building. When each component requires a service from another component, the services is requested using a URI which is resolved to a specific IP address and port number using a domain name system (DNS) server in the intranet. If two or more of the local processing host nodes are capable of providing a particular service, the DNS server returns a list of IP addresses, and rotates the ordering of the list for each query so as to attempt to distribute the traffic evenly among the identified servers. The conventional DNS URI resolution technique, however, suffers from a number of shortcomings, including expenditure of network and CPU resources on both the client and the DNS server to obtain the necessary data using asynchronous queries that require a waiting state. Furthermore, the obtained data may be obsolete and does not reflect the actual availability of the identified peer processing node. In the situation where several peer nodes can fulfill a given request, for example, the “round robin” type load distribution implemented by the conventional DNS server does not take into account the actual loading of the peer host processing nodes of the intranet, wherein overloaded host nodes will continue to be used even though other nodes are less loaded. In this regard, the local DNS server is rarely updated in real time with the operational state of the resources it resolves to, and furthermore, the DNS caching mechanism may considerably delay the availability of the status information to the processing node. Moreover, the current DNS approach does not provide for load shedding or admission control, whereby the DNS server continues to resolve to a peer node even if it is overloaded. In addition, adding or removing a resource from the network is complicated in a DNS architecture because even though a resource could be removed from the DNS server immediately, the caching mechanism used by the other (requesting) nodes will retain the record of this resource and will continue to attempt to use it for a significant time. Also, the local DNS server must be closely provisioned and managed to maintain an accurate URI to IP address translation capability. Thus, there is a need for improved methods and systems for resolving resource names or URIs to IP addresses in an intranet.

### SUMMARY OF THE INVENTION

The following is a summary of one or more aspects of the invention provided in order to facilitate a basic understanding thereof, wherein this summary is not an extensive overview of the invention, and is intended neither to identify certain elements of the invention, nor to delineate the scope of the invention. The primary purpose of the summary is, rather, to present some concepts of the invention in a simplified form prior to the more detailed description that is presented hereinafter.

The various aspects of the present disclosure relate to systems and methods for resolving URIs to IP addresses and port numbers in an intranet, wherein host processing nodes or peers maintain a local data store with entries indicating the status of service application ports (SAPs) provided by the other hosts of the intranet. URIs within the intranet are resolved at the host processing nodes without DNS server consultation by local address resolution components that can provide load shedding and load balancing according to the data store entries. The local hosts provide regular reports that are broadcast throughout the intranet to provide up to date status information for the SAPs, allowing a host requiring a particular URI to locally resolve the URI to one or more IP addresses and port numbers based on the locally stored status information, and to also implement load shedding and balancing. By locally caching the address resolution information as well as the status information, URIs can be resolved to local IP addresses and port numbers within the intranet quickly using less processing resources and also mitigating host processor overloading to balance the loading of host processing nodes that are able to service a given request.

One or more aspects of the disclosure relate to a system for resolving a unified resource identifier to an Internet address and a port number in an intranet formed by a plurality of host processing nodes. The system comprises an address resolution system of a first host processing node having a service application port data store and a client component. The data store includes entries corresponding to SAPs of other host nodes, with the individual entries indicating an Internet address and a port number for the corresponding service application port. The client component resolves a URI for the first host to an Internet address and a port number according to the entries of the service application port data store. The resolution system may further include a server component that broadcasts reports indicating a status of one or more service application ports associated with the first host processing node to address resolution systems associated with other host processing nodes of the intranet. The client component in the first host receives the reports broadcast by other host processing nodes and updates the SAP data store entries accordingly, wherein the entries in certain embodiments may include loading indicators according to which the client component performs load balancing and/or load shedding when servicing URI resolution requests.

The local address resolution system may be interoperative with a local DNS server of the intranet, with the client component of the local host processing system referring address resolution requests to the DNS server for URIs that are not associated with a local SAP, whereby the local address resolution system can support conventional DNS requests and client applications need not be changed. In this manner, the service can locally resolve URIs to SAPs within the intranet quickly and efficiency to provide load balancing and overload protection, and can refer non-local URI resolution requests to the conventional DNS resolution system. Moreover, the local DNS server also receives the reports broadcast by host processing nodes of the intranet, and can then transfer the status information from the reports to a second DNS server outside the intranet, such as by notifying an upper layer DNS server that status information has been received to initiate transfer of local zone information.

Further aspects of the invention provide a data center for supporting multimedia services, comprising a plurality of host processing components, some of which providing SAPs for supporting multimedia services via a session initiation protocol (SIP) infrastructure, as well as address resolution systems individually associated with at least some of the data center hosts. The individual address resolution systems comprise a SAP data store with Internet address and port number entries corresponding to SAPs of the data center, as well as a client component providing URI resolution according to the SAP data store entries.

Still other aspects relate to a method for resolving a URI to an IP address and port number in an intranet. The method includes providing a SAP data store in one or more host processing nodes, which includes SAP entries indicating an IP address and a port number for the corresponding SAP, as well as broadcasting reports to host processing nodes of the intranet indicating a status of SAPs of the broadcasting host processing node. The method further comprises updating the entries of the service application port data store according to the received reports at host processing nodes having a SAP data store, and resolving URIs associated with SAPs of the intranet to corresponding IP addresses and port numbers according to the SAP data store entries. The method may further include load balancing and/or load shedding at least partially according to the loading indicators, and referring resolution requests to a DNS server for URIs that are not associated with an intranet SAP.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages and novel features of the invention will become apparent from the following detailed description of the invention when considered in conjunction with the drawings. The present invention may be embodied in the construction, configuration, arrangement, and combination of the various system components and acts or events of the methods, whereby the objects contemplated are attained as hereinafter more fully set forth, specifically pointed out in the claims, and illustrated in the accompanying drawings in which:

FIG. 1 is a system view illustrating an exemplary intranet with a number of host processing systems or nodes and a local DNS server, with some or all of the hosts including a local load distribution and admission control (LD-AC) address resolution system according to various aspects of the present disclosure;

FIG. 2 is a system view illustrating an exemplary IMS data center intranet for providing multimedia services via a number of processing nodes implementing various call session control functions (CSCFs) with local address resolution systems according to the present disclosure;

FIG. 3 is a system view of the IMS data center implemented using a number of next generation session servers (NGSSs) with local LD-AC resolution systems;

FIG. 4 is a system diagram illustrating further details of an exemplary local LD-AC address resolution system with a server component broadcasting status reports related to local service application ports (SAPs) as well as a client component and a SAP data store;

FIG. 5 is a schematic diagram illustrating an exemplary LD-AC server broadcast report;

FIG. 6 is a flow diagram illustrating an exemplary method for local URI resolution according to the present disclosure;

FIG. 7 is a schematic diagram illustrating an exemplary LD-AC SAP data store;

FIG. 8 is a simplified system diagram illustrating an exemplary host processing node in which an application or SIP stack requests URI resolution using a pre-DNS attempt to resolve the URI using the LD-AC client and delivery of the resolution request to a local DNS server for non-local URIs; and

FIG. 9 is a system diagram illustrating integration of local address resolution systems of the present disclosure with a conventional DNS system.

### DETAILED DESCRIPTION

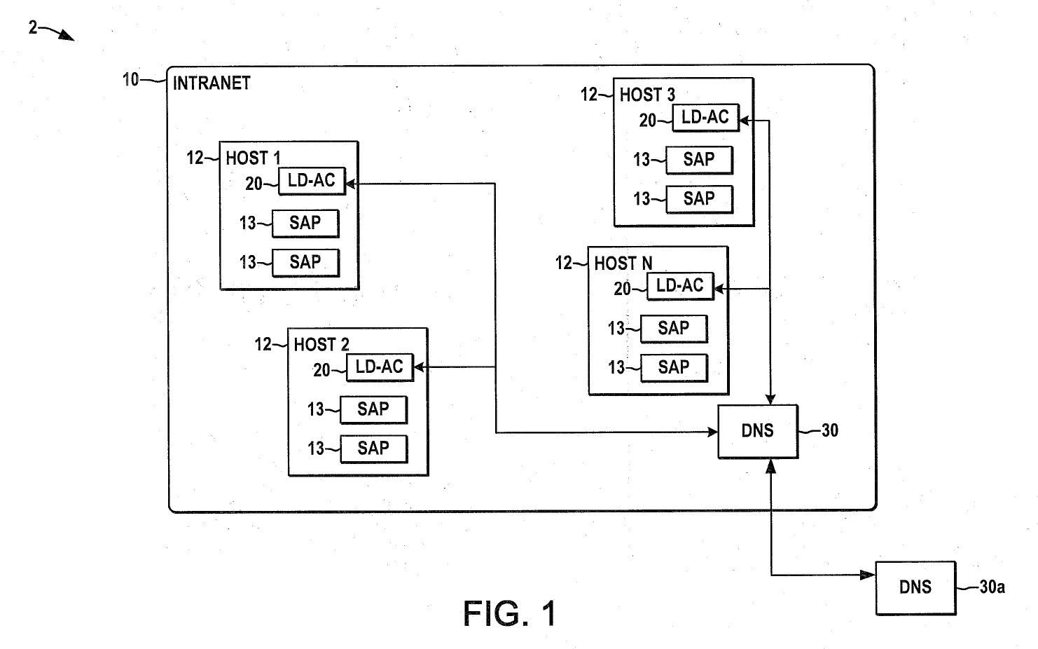

Referring now to the figures, wherein the showings are for purposes of illustrating the exemplary embodiments only and not for purposes of limiting the claimed subject matter, FIG. 1 schematically illustrates a packet switched computing system or network 2 including a local intranet 10 into which the presently described embodiments may be incorporated or in which various aspects of the invention may be implemented. Several embodiments or implementations of the various aspects of the present invention are hereinafter illustrated and described in conjunction with the drawings, wherein like reference numerals are used to refer to like elements throughout and wherein the figures are not necessarily drawn to scale. The illustrated system 2 can be any type of computing environment, such as a multimedia system processing calls and other multimedia sessions and will be described with particular reference thereto, although various aspects of the invention are not limited to any particular processing system or application. The system 2 includes one or more intranets 10 formed by a plurality of host processing nodes 12 which can be any suitable form of server or other processing entities, whether unitary or distributed, including suitable hardware, software, etc., or combinations thereof. Each host node 12 may support one or more instances of programs or software components or objects performing one or more tasks or services requested by an application within the intranet, wherein the hosts 12 and a local DNS server 30 share a common local zone domain and are operatively coupled with a local DNS server 30 of the intranet 10.

Applications as clients running on these hosts 12 may request access to a service application port (SAP) 13 hosted by a different host node 12 within the intranet 10, wherein a SAP 13 may be any interface port of a host 12 where a specific service is provided to a client, with each SAP 13 being assigned a URI which when resolved gives a unique IP address and port number combination used by a client in obtaining the requested service. Furthermore, there may be more than one SAP within the intranet that is capable of providing a desired service to an application. One or more of the processing nodes 12 include or are otherwise operatively associated with a Load Distribution and Admission Control (LD-AC) type address resolution system 20 for resolving URIs to an Internet address and a port number in the intranet 10, which also forwards URI resolution requests to the local DNS server 30 to resolve URIs of SAPs that are not part of the intranet 10 using one or more DNS servers 30a that are not part of the intranet 10.

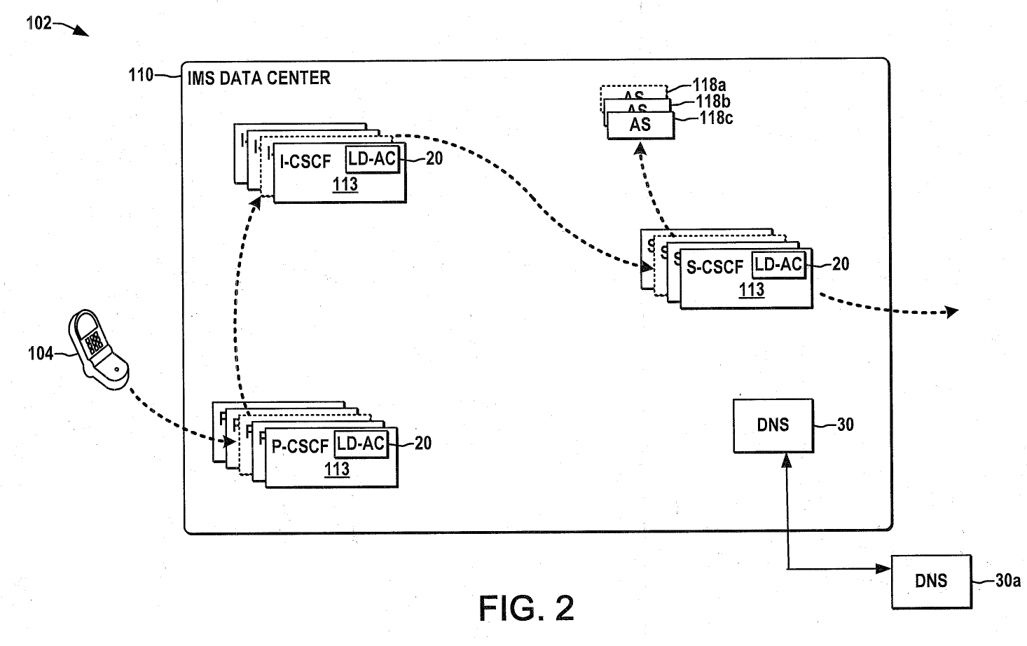

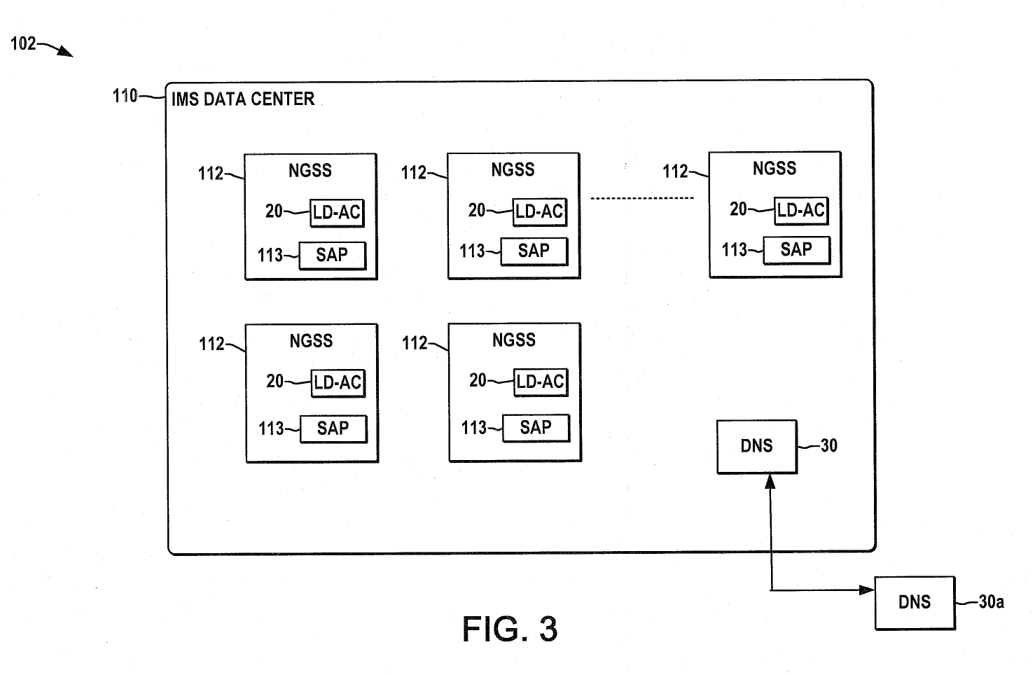

Referring also to FIGS. 2 and 3, an exemplary IMS data center 110 is shown in a communications system 102 which provides multimedia services for calls placed or received by a mobile device 104 via a number of Next Generation Session Server (NGSS) type processing nodes 112 implementing various call session control functions via CSCF SAPs 113 with local address resolution systems 20 provided locally in the processing nodes 112. As in the general case illustrated in the system 2 of FIG. 1, the IMS data center servers 112 may be any suitable hardware, software, or combinations thereof, whether unitary or distributed, by which one or more service application ports (SAPs) may be implemented in the local intranet 110. As shown in FIG. 2, various exemplary SAPs 113 are implemented in the data center intranet 1 10, including Proxy, Interrogating, and Serving CSCF SAPs 113, which are employed in processing calls placed by the mobile device 104. The data center 110 may further provide a multitude of different types of SAPs in various servers for supporting multimedia services according to a Session Initiation Protocol (SIP) or other suitable protocol, for example, such as application servers (AS), home subscription servers (HSS), subscriber location functions (SLF), gateway functions such as breakout gateway control functions (BGCF), media gateway control functions (MGCF), multimedia resource function control (MRFC), multimedia resource function processor (MRFP), signaling gateway functions (SGF), interconnection border control functions (IBCF), interconnection border gateway functions (I-BGF), etc. (not shown), the details of which are omitted in order to avoid obscuring the URI resolution features of the present disclosure.

In the illustrated IMS data center 110, a single server 112 of the IMS data center 110 may provide one or more instances of a Proxy Call Session Control Function (P-CSCF) 113, an Interrogation CSCF (I-CSCF) 113, a Serving CSCF (S-CSCF) 113, and/or other SAPs 113 available to provide certain services to one or more clients of the application servers 118 and the host processing nodes 112. In addition, one, some, or all of the NGSS server host nodes 112 comprises an LD-AC type address resolution system 20 for resolving URIs to an Internet address and a port number in the data center intranet 110. In the course of processing a call from the mobile 104, for instance, the P-CSCF 113 servicing the call may be provisioned to utilize the services of one of the available l-CSCFs 113 in the data center 110, and will accordingly request such services for SIP processing using a general URI label specifying the particular SAP type of ICSCF to service a SIP invite for authenticating the mobile 104 with an HSS function of the data center 110. The LD-AC system 20 of the P-CSCF resolves the URI to one or more pairs of IP addresses and port numbers for a suitable l-CSCF in the data center 110 and the requesting P-CSCF forwards the SIP invite to a selected I-CSCF. The l-CSCF, in turn, may be provisioned with a URI for a S-CSCF for processing SIP invites, and the I-CSCF uses its local LD-AC to resolve this URI to one or more suitable IP address/port number pairs from which the I-CSCF can direct the invite to an S-CSCF for downloading a user profile from an HSS function in the data center 110.

In performing various multimedia services for processing a call to or from the mobile 104 or other user devices, the host processing nodes 112 of the data center 110 thus need to resolve provisioned or non-provisioned URIs to IP addresses and port numbers, wherein the local LD-AC systems 20 provide this service using locally cached status information for URIs corresponding to SAPs within the datacenter intranet 110, and then refer such resolution tasks to the DNS server 30 for external SAPs. Moreover, the applications running on the host processing nodes 112, as clients, request the services and process the calls using suitable protocols, such as SIP and the conventional DNS URI resolution calls except as noted herein. In particular, the calls to the LD-AC address resolution systems 20 are the same as those made to conventional DNS URI resolution systems, wherein the applications themselves need not be modified in order to employ the LD-AC features set forth herein. For a typical URI resolution request, a client in one of the host processing nodes (NGSSS) 112 may submit a URI in the form SAP type.LZD with no service label (e.g., host IP address) and with the LZD label representing a local zone domain shared by the components of the intranet 110. In servicing this form of request, the LD-AC systems 20 note the lack of a service label and may thus resolve to any suitable host, and can therefore employ load distribution to select the best candidate host in resolving the URI. The local LD-AC system 20, in turn, will resolve this URI, if possible, into one or more sets of IP address and port number components for SAPs within the data center intranet 110 and otherwise will forward the URI to the DNS server 30 for resolution to SAPs outside the data center 110. In another possible request, a service label (host IP address) is provided, in which case the LD-AC system 20 performs a URI to IP address/port number resolution with no load distribution.

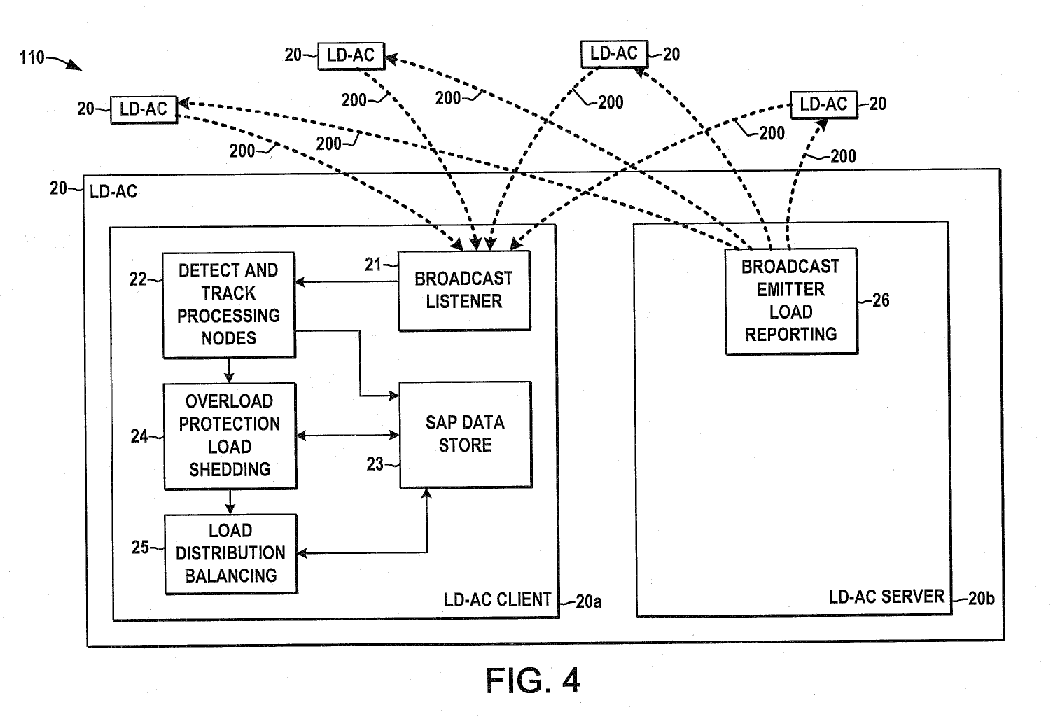

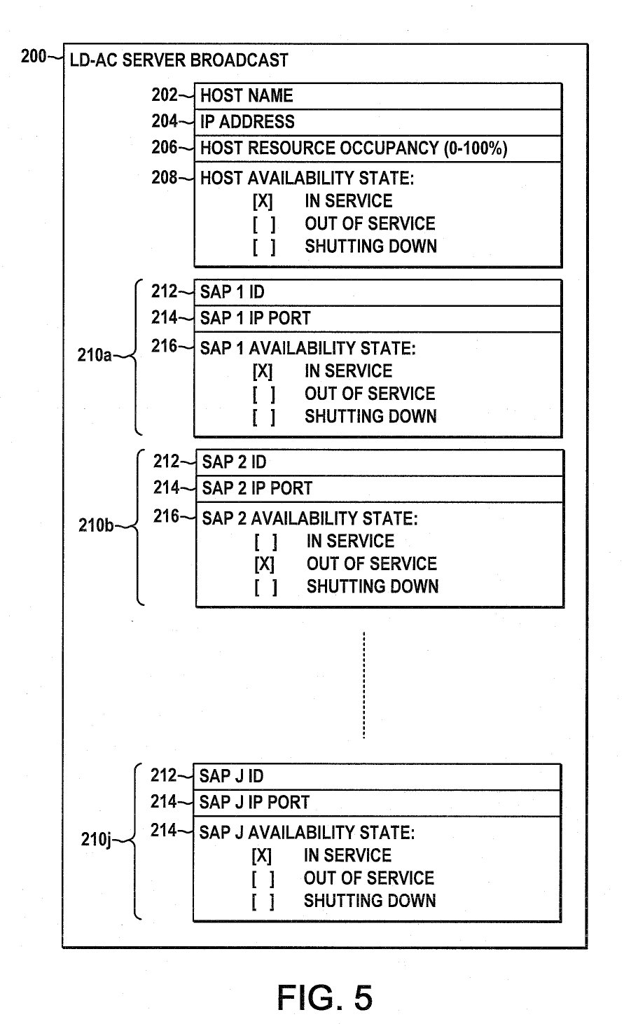

Referring also to FIGS. 4-8, FIG. 4 depicts further details of the exemplary local LD-AC type address resolution systems 20, wherein one or more of the systems 20 include both a client component 20a and a server component 20b as shown in FIG. 4, and certain of the LD-AC systems 20 may be implemented with just a server component 20b (e.g., for a host processing node 112 that only provides services to other nodes) or just a client component 20a (e.g., for host processing nodes 112 that only consume services from other host SAPs 113). In general, the server 20b broadcasts SAP status information reports 200 to the LD-AC clients 20a of other hosts 112 via a broadcast emitted-load reporting component 26, and the client 20a receives the broadcast reports 200 sent by others, and operates to track the peer hosts 112 using the SAP data store 23, to calculate the load shedding if necessary for a given SAP 113, to calculate the optimal load distribution to each peer host processing node 112, and to resolve the requested URIs to SAPs 113 within the intranet 110. The address resolution system 20 may be implemented in the form of software operating in the associated host processing system node 112, hardware such as processing components, logic, etc., or combinations thereof, wherein a given address resolution system 20 can be a unitary component within or otherwise operatively associated with the corresponding host 112 or may be implemented as a plurality of inter-operative components, whether hardware and/or software. The LD-AC systems 20 of the intranet 110, moreover, are operatively associated with one another to exchange messages and data such as the exemplary broadcast report 200 shown in FIG. 5.

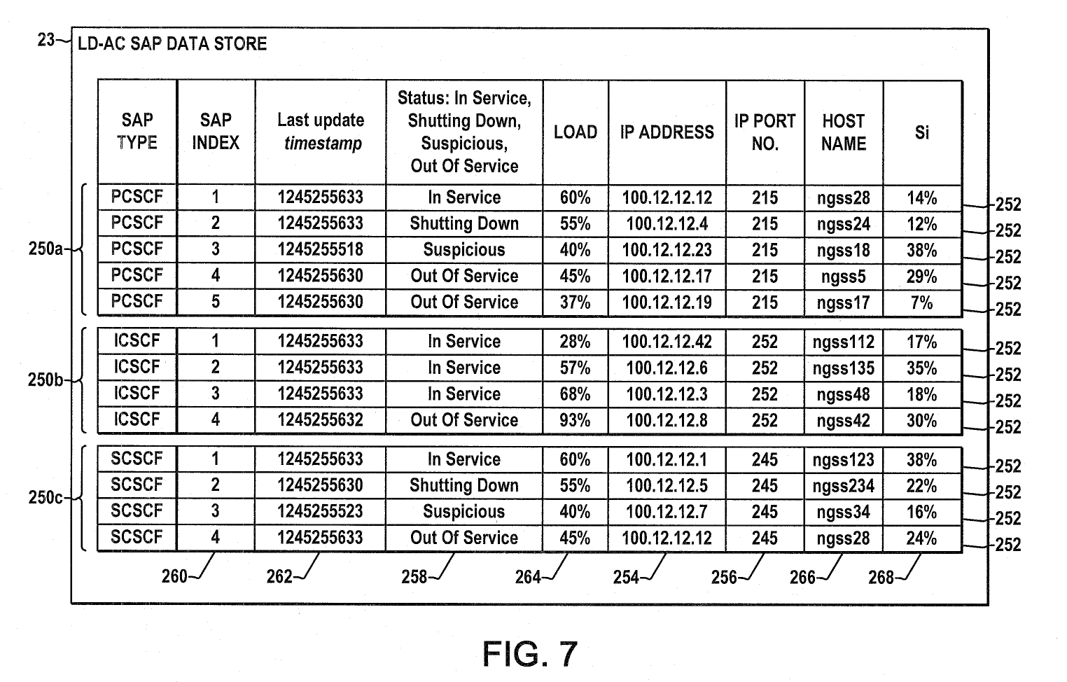

As best seen in FIGS. 4 and 7, the system 20 comprises a service application port (SAP) data store or table 23 with entries 252 corresponding to SAPs 113 of other host processing nodes 112 of the intranet 110, where the individual entries 252 indicate an Internet (IP) address 254 and a port number 256 for the corresponding SAP 113. The entries 250 in the embodiment of FIG. 7 are listed in groups or clusters 250a, 250b, 250c, etc. according to SAP type (e.g., corresponding to the SAP type portion of the URI being resolved by the LD-AC system 20), wherein the illustrated groups 250a-250c correspond to SAPs 113 able to provide proxy, interrogating, and serving CSCF services in an IMS data center intranet 110, and wherein the illustrated groups 250 and entries 252 are merely examples and the invention is not limited to the illustrated SAP types or groupings. Other embodiments are possible, wherein different types of data are provided in the data store entries 252 and/or where the entries 252 are of different organization or form than those shown in FIG. 7. As best shown in FIG. 4, the client component 20a of the LD-AC system 20 includes a broadcast listener component 21 that receives reports 200 broadcast by LD-AC systems 20 of other host processing nodes 112 in the intranet 110, wherein a detect and track component 22 within the client 20a maintains and updates the SAP data store entries 252 according to status and other information provided by the broadcast reports 200.

In one implementation shown in FIG. 5, the reports 200 include the sending host name 202 and host IP address 204, along with the host resource occupancy 206 (e.g., 0-100% in one example), a host availability state 208 (e.g., “in service”, “out of service”, or “shutting down” in one implementation), and one or more SAP information sets 210a-210j for a host 112 reporting the status and availability of an integer number “j” SAPs 113. In one embodiment, the host resource occupancy 206 represents the composite host loading including host CPU load, the memory usage, and occupancy of any other host resource. The occupancy value 206 in one implementation is the worst-case resource usage, for instance, where a 55% CPU usage and an 80% memory usage will be reflected as an 80% host occupancy value 206. For each SAP 113 associated with the reporting host 112 in the example of FIG. 5, the SAP information sets 210 include a SAP ID 212, the SAP port number 214, and a SAP availability state 216 indicating one of several possible SAP states: “in service”, “out of service”, or “shutting down”. In another aspect, the LD-AC systems 20 may report a composite loading or occupancy value for each SAP 113 (e.g., alternatively or in combination with host occupancy values 206) in order to account for situations where some scarce resource may be linked to one particular SAP 113 but not to others on the same host 112. In one example, a P-CSCF SAP 113 may have a limited number of registries, in which case the load factor for this SAP 113 will reflect the registry usage. Moreover, the LD-AC server broadcast reports 200 may further provide the preferred IP transport (e.g., UDP, TCP, SCTP, etc.).

Using this information 210 from the report 200, the detect and tracking component 22 of the LD-AC client 20a (FIG. 4) updates the entries 252 of the SAP data store 23 (FIG. 7) to indicate a timestamp 262 showing when the entry 252 was last updated, the SAP status 258 (from the report SAP availability state 216 in FIG. 5), the host CPU loading (e.g., from the host CPU resource occupancy 206 in FIG. 5), the IP address 254 (from the host IP address field 204 in the report 200), the port number 256 (from the SIP port number field 214 in the report 200), and the host name 266 (from the report field 202 in FIG. 5). Moreover, the component 22 may implement one or more logic rules in maintaining and updating the SAP data store 23. For example, the exemplary component 22 in one embodiment is adapted to read the list of SAPs 113 provided by the host report 200, and if the reporting host 112 is “Out Of Service” (as shown in field 208 of the report 200), each corresponding SAP 113 is also marked as “Out Of Service”, regardless of the indicated SAP availability status 216 in the report 200. Otherwise, each SAP 113 that is not “Out Of Service” is added or refreshed in the data store 23, except that SAP entries that were previously “In Service” or “Shutting Down”, and that have not been refreshed for more than a given amount of time (e.g., two or more broadcast reporting intervals in one implementation) are set in a “suspicious” state using the timestamp information 262, and SAPs 113 that were previously in the “suspicious” state are then discarded (e.g., removed from the data store 23) if not refreshed by an “in service” report 200. In one implementation, the LD-AC server components 20b send reports 200 on a regular basis, such as about every 3 seconds in one example, although the invention is not limited to periodic reporting or other regular reporting interval.

In the illustrated implementation, each LD-AC 20 thus reports to each of the other LD-AC systems 20 of the intranet 110, and each SAP data store 23 is thus maintained and updated locally at the host nodes 112. As a result, each SAP data store 23 provides a local cache of SAP status information from which the LD-AC client components 20a can provide URI resolution for URIs in the intranet 110, and can also perform load balancing and shedding functions so as to evenly distribute loads among the possible SAPs adapted for a requested service. As shown in FIG. 4, the exemplary LD-AC client 20a includes an overload protection-load shedding computation component 24 operatively coupled with the SAP data store 23 that uses the loading entries 264 to compute a load shedding ratio P for protection of clusters of the same SAP type (e.g., the cluster of S-CSCFs indicated in the group 250a of FIG. 7). In the illustrated example, the loading entries 264 reflect the loading of the host CPU as well as memory usage and other resource usage rates related to the host.

In addition, the exemplary client 20a includes a load distribution-load balancing component 25 that uses the loading entries 264 to compute a load balancing factor or value Si 268 for each SAP 113, which is then indicated in the data store 23. In the illustrated LD-AC system 20, each SAP 113 that was previously “in service” but which is not in service anymore will trigger an re-calculation of the load distribution algorithm, the load distribution computation only considers SAPs 113 that are in service, and the SAP/Host Name to IP and port number resolution considers all SAPs 113 in the data store 23 that are not “Out Of Service”.

For overload protection (load shedding), the client component 20a computes a shedding ratio P for each SAP group or cluster 250, and may employ any suitable algorithm or computation that prevents or inhibits resource overloading in operation of the SAPs 113. One possible implementation is set forth in U.S. Pat. No. 4,974,256 to Cyr et al., assigned to the assignee of the present invention, the entirety of which is hereby incorporated by reference as if fully set forth herein, although any other algorithm that provides load shedding can be used. In addition, while the load distribution and load shedding algorithms may be performed locally as shown in the illustrated implementations, these can alternatively be performed in one location with the results being replicated to the local SAP data stores 23. Likewise, the LD-AC session distribution processing can either be centralized in one place in the intranet 110 or can be distributed in the local LD-AC systems 20 which have a client component 20a. The load shedding feature advantageously ensures that the overall CPU resources for a given SAP 113 are not saturated, and is generally implemented by selectively shedding all or part of the incoming processing load (e.g., for new calls in an IMS data center intranet implementation 110) to protect the SAP cluster 250, and the load shedding is done at the source according to the calculated load shedding ratio P. In one example, the ratio P for each SAP cluster 250 is computed according to the following equation, in which P(t+1) is the calculated shedding at time “t+1”, and P(t) is the previous shedding ratio at time “t”:

$$if ( ( A > T ) ⋁ ( {P}_{t} < 1 ) ) -> {P}_{t + 1} = {P}_{t} [ 1 + \frac{( T - A ) G 2}{A} ]$$

$$if ( {P}_{t + 1} > 100 \% ) {P}_{t + 1} = 100 \%$$

$$if ( {P}_{t + 1} < 5 \% ) {P}_{t + 1} 5 \%$$

$$Initial\_Condition: {P}_{0} = 100 \%$$

In this implementation, Pt is the load shedding ratio at time “t”, T is a threshold for load shedding (e.g. which may be provisioned for the LD-AC system 20), G2 is a dimensionless (provisioned) gain factor, and A is the average CPU load in all the hosts 112 of a SAP cluster 250 (e.g., all the hosts 112 with SAPs 113 able to perform a given SAP service type). In one possible example, the threshold value T defaults to 85%, although any suitable value can be used. The result of the calculation (P) gives the ratio of new call requests in an IMS data center implementation that should be rejected (e.g., call load shedding).

For load distribution (access control), the load balancing component 25 employs the host loading information 264 from the SAP data store 23 in computing Si values 268 so as to distribute traffic (e.g., new sessions) to the surrounding processing hosts 112 of the intranet 110 with the goal of equalizing the CPU resource occupancy in each SAP cluster 250. Any suitable computation can be used that tends to evenly distribute the load for the services provided by the SAPs 113 in the intranet 110. The load balancing computation in one possible embodiment provides a value Si for each processing node “i” computed according to the following formula, where S(t+1, i) is the calculated ratio at time “t+1” for node “i” and S(t,i) is the previous ratio at time “t” for node “i”.

$${S}_{t + 1 , i} = {S}_{t} + \frac{( A - {a}_{i} ) G 1}{N}$$

$$Initial\_Condition: ∀ i , {S}_{0 , i} = \frac{1}{N}$$

In this example, St,i is the fraction of new traffic allowed or provided to a given host processing node “i” 112 at time “t”, A is the average CPU load (ratio) in all the hosts 112 available for the considered SAP 113, ai is the last known CPU load (ratio) of node “i”, G1 is a unitless gain factor (e.g. provisioned with a default of 1), and N is the number of processing hosts 112 available in a given cluster or group to process the considered SAP 113 (e.g., the number of hosts 112 within the considered SAP cluster 250 in FIG. 7). In the exemplary embodiment, the load balancing algorithm is run at every broadcast reporting interval (e.g., about every 3 seconds in one example) using the values updated in the SAP data store 23 in order to populate the Si column. In addition, for the illustrated implementation, when a processing node “j” has been added, S(j) is initialized as 1/N, with N being the new number of processing hosts 112 available for the considered SAP 113.

In the illustrated implementation, once the data store 23 has been updated with received reports 200, the client 20a of a given local host processing node 112 performs selective URI resolution services for the local host 112 to resolve a URI associated with a SAP 113 of the intranet 110 to an IP address and a port number according to the entries 252 of the SAP data store 23, using the load shedding and balancing factors P and Si. A spreading algorithm can then be employed to distribute the new sessions to hosts 112 during the subsequent interval until another set of reports 200 are received in the LD-AC system 20, wherein any suitable spreading algorithm or methodology can be employed by which the resulting distribution of URI resolution results is close to the determined ratios P and S, or to at least tend to ensure that an overloaded host processing node 112 does not receive new requests, wherein the distribution to a particular (non-overloaded) node 112 is preferably spread as far as possible over the entire time interval. Simple embodiments can be employed in this regard to spread the incoming URI resolution request load, for instance, wherein the next available and not previously used SAP 113 is selected for which if the CPU load is less than a SAP CPU overload value, where the overload value threshold can be any suitable provisioned or dynamically adjusted value, such as about 85% in one example. In this case, the LD-AC advantageously excludes ‘out-of-service’ SAPs 113 from the spreading. In another possible implementation, a simple distribution mechanism may be employed for which the load distribution factors Si are calculated at the LD-AC updates and an interval is assigned to each SAP “SAPi” of a SAP cluster, with the interval beginning with 1+ the sum of all the SAP “Si” with a lower index”, and ends with this previous number plus the “Si” of this SAP (e.g., P-CSCF 1: 0-14; P-CSCF 2: 15-26; P-CSCF 3: 27-64; P-CSCF 4: 65-93; P-CSCF 5: 94-100, for a total of 100). Thus, each available SAP will be apportioned appropriate portions of the range from 0 to 100 according to the load distribution factors Si. In this example, each time a node is to be resolved or selected for the SAP cluster type, the resolving LD-AC system 20 obtains a random number from 0 to 100 and resolves to (e.g., selects) the P-CSCF SAP node having the interval corresponding to the random number. In this manner, the least loaded SAPs 113 will have the highest probability of being selected and efficient load balancing is achieved.

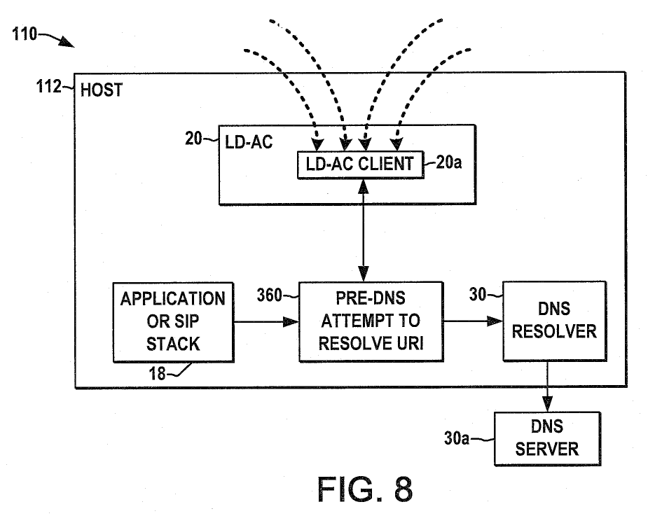

Referring to FIG. 8, when an application or SIP stack 18 within a given host processing node 112 requires resolution of a particular URI to an IP address and port number, a pre-DNS resolution attempt 360 is undertaken wherein the LD-AC client 20a of the requesting host 112 consults the SAP data store 23 as described above. If the requested URI corresponds to an available SAP 113 within the intranet 110, and if the request is not subjected to load shedding by the client 20a, the LD-AC address resolution system 20 returns an IP address and port number of a suitable SAP 113 within the intranet 110 according to any load distribution algorithm or technique employed by the client 20a, and the application or SIP stack 18 then uses the SAP services accordingly, without need for any extra access of the DNS systems 30, 30a. Otherwise, if the service cannot be provided locally within the intranet 110, the LD-AC system 20 forwards the URI resolution request to the local DNS server 30 of the intranet 110, which then returns an appropriate external IP address and port number using conventional DNS techniques, which may include consultation with an external DNS server 30a.

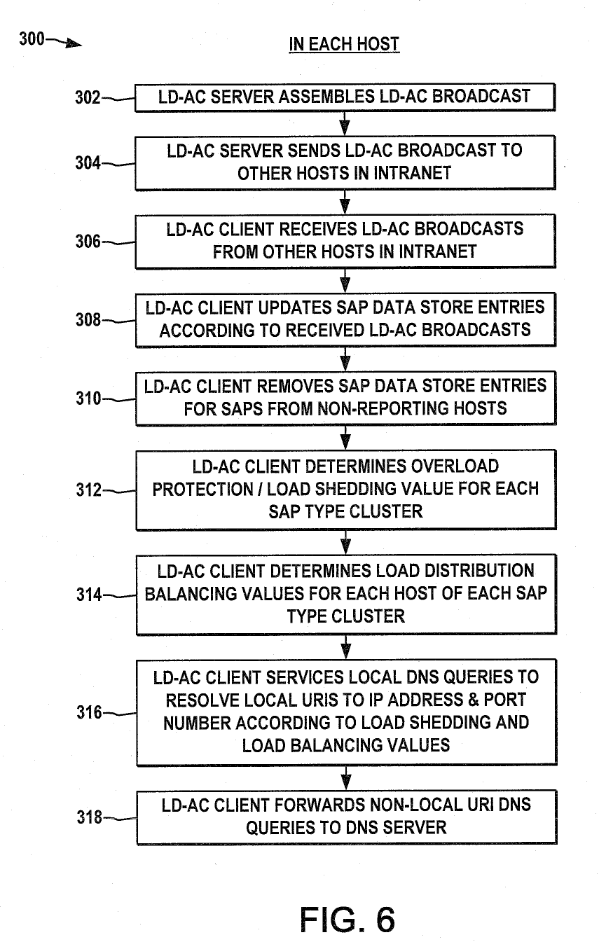

Referring also to FIG. 6, a flow chart 300 depicts an exemplary URI resolution method in accordance with various aspects of the present disclosure. While the exemplary method 300 is illustrated and described below in the form of a series of acts or events, it will be appreciated that the various methods of the invention are not limited by the illustrated ordering of such acts or events except as specifically set forth herein. In this regard, except as specifically provided hereinafter, some acts or events may occur in different order and/or concurrently with other acts or events apart from those illustrated and described herein, and not all illustrated steps may be required to implement a process or method in accordance with the present invention. The illustrated method 300 and other methods of the invention may be implemented in hardware, software, or combinations thereof, in order to provide URI resolution services to host processing nodes 112 in a packet-switched processing environment such as those illustrated and described above, although the invention is not limited to the specific applications and implementations illustrated and described herein.

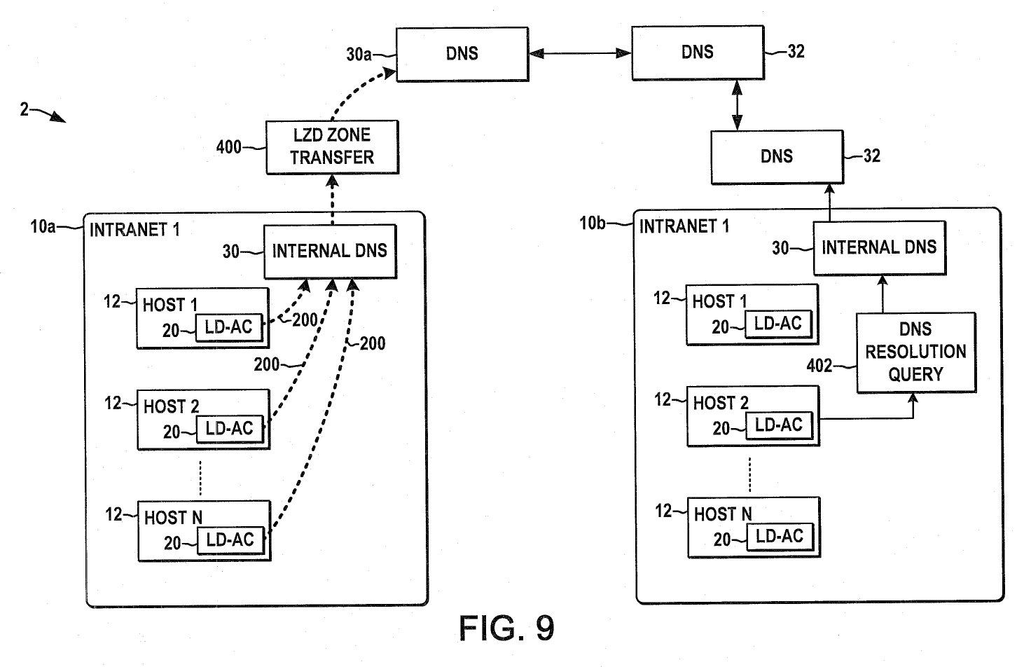

Beginning at 302 in FIG. 6, the method 300 includes the LD-AC server component (20b in FIG. 4 above) of each reporting host 112 assembling a broadcast report 200 (FIG. 5) at 302 based on the current status of the SAPs 113 associated with the reporting host 112, after which the server 20b sends the broadcast report 200 to the other hosts 112 (at least those hosts 112 having an LD-AC client component 20a) of the intranet 110. At 306, the LD-AC client component 20a of each host node 112 receives the broadcast reports 200 from the reporting LD-AC servers 20b of other hosts 112 of the intranet 110, and these reports 200 are also received at the local DNS server 30, as described further below with respect to FIG. 9. The LD-AC client 20a then updates the entries 252 of the SAP data store 23 at 308 according to the received LD-AC broadcast reports 200, and removes entries 252 corresponding to SAPs 113 of non-reporting hosts 112 at 310. At 312, the LD-AC client 20a performs load shedding by computing the overload protection-load shedding factors P for each SAP cluster 250, and also performs load balancing or distribution at 314 by computing the balancing values Si for each host 112 of the clusters, with these values optionally being saved as the last column in the exemplary SAP data store table 23 of FIG. 7. At 316, the LD-AC client 20a services local DNS queries by selectively resolving URIs to IP addresses and port numbers according to the load shedding and balancing values, and forwards non-local URI queries to the local DNS server 30 at 318, with the processing 300 being repeated at each LD-AC reporting interval.

By the above described techniques, the local LD-AC systems 20 facilitate overload protection and load balancing within the intranet 110, along with expeditious URI resolution for services provided by SAPs 113 within the intranet 110. In this regard, the various aspects of the present disclosure are generally applicable to any system in which URI resolution is utilized, and can be implemented so as to avoid any changes in the DNS type interface provided to requesting applications or SIP stacks 18. Moreover, the disclosure finds particular utility in systems where a significant amount of services are provided locally within a given intranet, such as the exemplary IMS data center 110 illustrated and described above. In this respect, where a large number of requested URIs are resolved within the requesting host's intranet, the LD-AC systems 20 provide fast URI resolution to applications or SIP stacks 18 without requiring access to the local DNS server 30 or external DNS servers 30a (FIGS. 1-3 above) and the associated expenditure of network and CPU resources. In addition, the distributed LD-AC approach can also facilitate load balancing and shedding within the intranet 110 to more efficiently direct service requests to SAPs 113 and host processors 112 best able to handle incoming loading.

Referring also to FIG. 9, as discussed above, the local DNS server 30 in certain embodiments is operative to receive the broadcast reports 200 from the reporting LD-AC systems 20 within each of the intranets 10 of a computing or network system 2, as well as to receive URI address resolution requests for SAPs outside the requesting host's intranet 10. The DNS architecture, in certain embodiments of the present disclosure, can be more closely integrated with the LD-AC systems 20 with the local DNS server 30 operating to transfer status information from the received reports 200 to one or more external DNS servers 30a, 32 outside the intranet 10, for instance, by notifying the upper layer DNS server 30a that new information is received (e.g., from the reports 200) and to cause the upper DNS server(s) 30a, 32 to initiate the transfer of local zone information 400. In this manner, the DNS system at large is updated with the status of the SAPS 112 of reporting hosts 12 of the first intranet 10a, whereby conventional DNS servicing of a resolution query 402 from another intranet 10b can be done intelligently according to the status of a SAP in the first intranet 10a.

By this closer integration of the DNS system and one or more local LD-AC systems, other nodes in remote locations can benefit by knowledge of accessibility and load information related to SAPs they need to utilize. Thus, even though the DNS information may not be updated and distributed in real time (e.g., every few seconds in certain embodiments) as can be done locally through the LD-AC systems 20 within a given intranet 10, the DNS information can nevertheless be updated or refreshed in “quasi-real-time”, for instance, every few minutes using local zone transfers 400. Remote requesting applications can thus be aware of the accessibility of local SAPs 113 and hosts 12 since non-responsive local component records can be quickly removed from the DNS system at large, thereby enhancing the overload protection and load distribution capabilities throughout the system 2. Furthermore, the “weight” in the SRV records can be updated frequently using the server occupancy information broadcast by the LD-AC systems 20.

In the illustrated example of FIG. 9, the local DNS server 30 in the first intranet 10a is updated with fresh accessibility information via the frequent broadcast reports 200 from the LD-AC servers 20b, by which the server 30 can remove internal DNS A and SRV records associated with any non-responsive host processing nodes 12, and can update the weights in the internal SRV records. The local DNS server 30 can then notify the upper layer DNS system 30a, 32 to initiate transfer of the “local zone” fresh information 400. Thereafter, DNS URI resolution queries 402 from anywhere will avoid resolution to any nodes 12 that are not working, and the updating of the SRV “weight” records will reflect the actual load of each node 12 so that the traffic allocation can be better distributed.

Although the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A system for resolving a unified resource identifier to an Internet address and a port number in an intranet formed by a plurality of host processing nodes, comprising:
an address resolution system associated with a first host processing node, comprising:
a service application port data store with entries corresponding to service application ports of other host processing nodes of the intranet, the individual entries indicating an Internet address and a port number for the corresponding service application port; and
a client component providing unified resource identifier resolution services for the first host processing node, the client component being operatively coupled with the service application port data store to resolve a unified resource identifier associated with a service application port of the intranet to an Internet address and a port number according to the entries of the service application port data store.

2. The system of claim 1, wherein the address resolution system associated with the first host processing node further comprises a server component that broadcasts reports indicating a status of one or more service application ports associated with the first host processing node to address resolution systems associated with other host processing nodes of the intranet.

3. The system of claim 1, wherein the client component receives reports broadcast by other host processing nodes of the intranet, the reports including a status of one or more service application ports associated with the other host processing nodes, and wherein the client component updates the entries of the service application port data store according to the received reports.

4. The system of claim 1, wherein the entries of the service application port data store include loading indicators associated with the other host processing nodes, and wherein the client component performs load balancing at least partially according to the loading indicators.

5. The system of claim 1, wherein the entries of the service application port data store include loading indicators associated with the other host processing nodes, and wherein the client component performs load shedding at least partially according to the loading indicators.

6. The system of claim 5, wherein the client component performs load balancing at least partially according to the loading indicators.

7. The system of claim 6, wherein the client component receives reports broadcast by other host processing nodes of the intranet, the reports including a status of one or more service application ports associated with the other host processing nodes, and wherein the client component updates the entries of the service application port data store according to the received reports.

8. The system of claim 7, wherein the address resolution system associated with the first host processing node further comprises a server component that broadcasts reports indicating a status of one or more service application ports associated with the first host processing node to address resolution systems associated with other host processing nodes of the intranet.

9. The system of claim 1, wherein the client component refers address resolution requests to a DNS server associated with the intranet for unified resource identifiers that are not associated with a service application port of the intranet.

10. The system of claim 9, wherein the DNS server associated with the intranet receives reports broadcast by host processing nodes of the intranet, the reports including a status of one or more service application ports associated with the host processing nodes of the intranet.

11. The system of claim 10, wherein the DNS server associated with the intranet transfers status information from the reports to a second DNS server outside the intranet.

12. A data center for supporting multimedia services, comprising:
a plurality of host processing components, at least some of which providing one or more service application ports individually associated with unified resource identifiers for supporting multimedia services via a session initiation protocol infrastructure;
a plurality of address resolution systems individually associated with at least some of the host processing components of the data center, with each of the address resolution systems comprising:
a service application port data store with entries corresponding to service application ports provided by host processing components of the data center, the entries indicating an Internet address and a port number for the corresponding service application port; and
a client component providing unified resource identifier resolution services for the corresponding host processing component, the client component being operatively coupled with the service application port data store to resolve a unified resource identifier associated with a service application port of the data center to an Internet address and a port number according to the entries of the service application port data store.

13. The data center of claim 12, wherein at least some of the address resolution systems further comprise a server component that broadcasts reports indicating a status of one or more service application ports associated with the corresponding host processing component to address resolution systems associated with other host processing components of the data center.

14. The data center of claim 12, wherein the client components each receive reports broadcast by other host processing components of the data center, the reports including a status of one or more service application ports associated with the other host processing components, and wherein the client components update the entries of the corresponding service application port data stores according to the received reports.

15. The data center of claim 12, wherein the service application port data store entries include loading indicators associated with the service application ports, and wherein the client components perform load balancing at least partially according to the loading indicators.

16. The data center of claim 12, wherein the service application port data store entries include loading indicators associated with the service application ports, and wherein the client components perform load shedding at least partially according to the loading indicators.

17. The data center of claim 12, further comprising a DNS server, wherein the client components refer address resolution requests to the DNS server for unified resource identifiers that are not associated with a service application port of the data center.

18. A method for resolving a unified resource identifier to an Internet address and a port number in an intranet formed by a plurality of host processing nodes, the method comprising:
providing a service application port data store in at least some of the host processing nodes, the service application data stores including entries corresponding to service application ports of the intranet, the individual entries indicating an Internet address and a port number for the corresponding service application port;
at host processing nodes that provide at least one service application port of the intranet, broadcasting reports to other host processing nodes of the intranet, the reports indicating a status of service application ports of the broadcasting host processing node;
at host processing nodes having a service application port data store, updating the entries of the service application port data store according to the received reports; and
at host processing nodes having a service application port data store, resolving unified resource identifiers associated with service application ports of the intranet to corresponding Internet addresses and port numbers according to the entries of the service application port data store.

19. The method of claim 18, wherein resolving unified resource identifiers to corresponding Internet addresses and port numbers comprises load balancing at least partially according to the loading indicators.

20. The method of claim 18, wherein resolving unified resource identifiers to corresponding Internet addresses and port numbers comprises load shedding at least partially according to the loading indicators.

21. The method of claim 18, further comprising, at host processing nodes having a service application port data store, referring address resolution requests to a DNS server associated with the intranet for unified resource identifiers that are not associated with a service application port of the intranet.

22. The method of claim 18, further comprising, at a DNS server associated with the intranet, receiving the reports broadcast by host processing nodes of the intranet, and transferring status information from the received reports to a second DNS server outside the intranet.
